(19) United States
(12) Patent Application Publication
(10) Pub. No.: US 2007/0102413 A1
(43) Pub. Date: May 10, 2007

(54) Heat preservation pad

(75) Inventor: Chiao-Ming Wang, Taichung Hsien (TW)

Correspondence Address: BRUCE H. TROXELL;SUITE 1404, 5205 LEESBURG PIKE, FALLS CHURCH, VA, 22041, US

(73) Assignee: Meiko Pet Corporation

(21) Appl. No.: 11/267,501

(22) Filed: Nov. 7, 2005

(51) Int. Cl. H05B 1/00; H05B 3/34

(52) U.S. Cl. 219/217; 219/528

(57) ABSTRACT

A heat preservation pad to maintain a warm condition for a long period of time includes a base, a upper cap, an inner box and a heating assembly. The base is coupled with the upper cap to form a housing compartment to hold the inner box. The inner box contains a heat transfer medium wax and has a bottom surface attached to the heating assembly to generate heat energy. The heating assembly contains a thermostat which constantly detects the temperature of the inner box to turn on or off electric power supply. Through heat transfer of the inner box the heat preservation pad can maintain a warm condition for a long period of time even if the electric power is absent.

### BACKGROUND OF THE INVENTION

1. Field of the Invention

The invention relates to a heat preservation pad and particularly to a pad capable of keeping warm for a long period of time.

2. Description of the Prior Art

Nowadays many people love to keep pets. There are a wide variety of products on the market to cater the welfare of pets. To keep the pets warm in the cold weather is important. Hence many types of warming goods such as warming blankets and beds have been introduced to enable the pets without sleeping on a damp or cold floor and prevent the pets from inflicting ailments. Those goods are mostly heated electrically. Hence electric power has to be supplied constantly to generate heat energy and maintain a warm condition. If electric power supply is unstable or interrupted, or the unplugging of the power cord occurs due to messing around of the pets, warming keeping function of the warming blankets or beds become ineffective. Moreover, warming by supplying electric power constantly could result in the risk of overheating. This could produce a not comfortable condition to the pets.

### SUMMARY OF THE INVENTION

In view of the problem occurred to the conventional heat preservation structure that cannot maintain a warm condition for a long period of time when the electric power is absent, the present invention aims to provide a heat preservation pad that can maintain a steady temperature for a long period of time to maintain a desired warm condition.

The invention mainly includes a base, a upper cap, an inner box and a heating assembly. The base and the upper cap are coupled together to form a housing compartment to hold the inner box. The inner box has a housing chamber to hold a wax as a heat transfer medium. The inner box has an opening sealed by a lid to form a closed condition and a bottom surface attached to the heating assembly to generate heat energy. The heating assembly has a thermostat which constantly detects the temperature of the inner box to turn on or off the supply of electric power. Through heat transfer of the inner box the heat preservation pad can maintain a warm condition. Therefore the temperature can be maintained as desired. Moreover, the heat preservation pad can be held in a pliable fabric pouch to enhance comfort and heat preservation. The wax has a low melting temperature and disperses heat slowly, thus can maintain a warm condition for a long period of time even if the electric power is cut off.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of the invention.

FIG. 2 is a sectional view of the invention in an assembled condition.

FIG. 3 is a schematic view of an embodiment of the invention.

FIG. 4 is a sectional view of an embodiment of the invention in an assembled condition.

### DESCRIPTION OF THE PREFERRED EMBODIMENTS

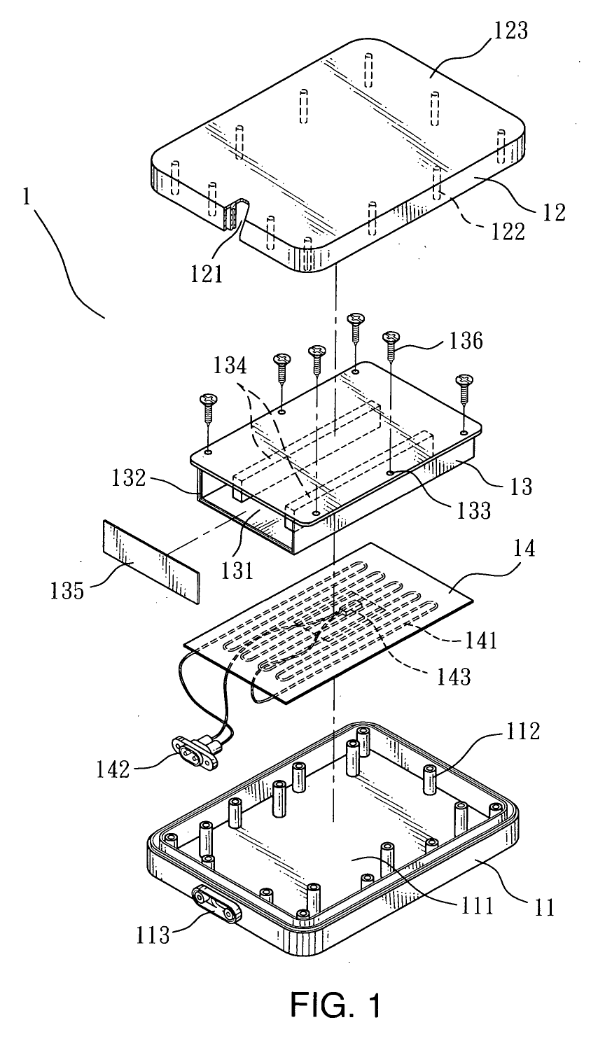

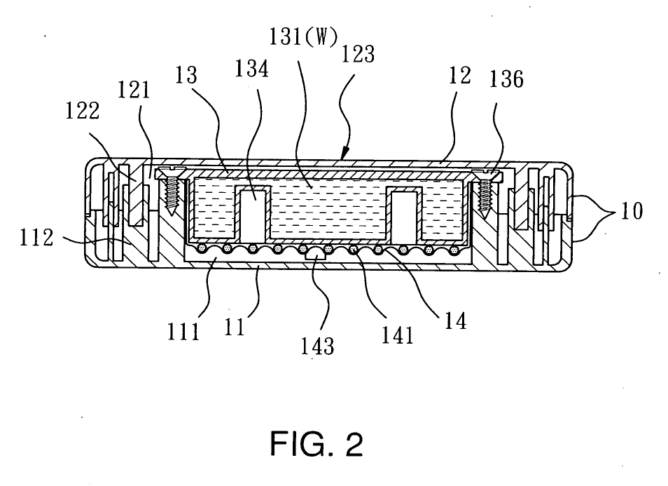

Referring to FIGS. 1 and 2, the invention includes a base 11, a upper cap 12, an inner box 13 and a heating assembly 14.

The base 11 is coupled with the upper cap 12 to form a chest 10 that has a housing compartment 111 to hold the inner box 13. It also has a plurality of coupling posts 112 on the periphery and an anchor seat 113 on an outer side.

The upper cap 12 is coupled on a upper side of the base 11, and has a heat receiving surface 123 on a upper side thereof and a housing trough 121 formed in the interior. It also has a plurality of struts 122 on the periphery corresponding to the coupling posts 112 of the base 11 so that they can be coupled together to form a housing space.

The inner box 13 is held in the housing space formed by the base 11 and the upper cap 12, and has a housing chamber 131 to hold wax W. It has one or more trough 134 on the bottom and an opening 132 on one end, and apertures 133 on two sides to receive screws 136 to fasten to the base 11. The opening 132 is sealed by a lid 135 to allow the housing chamber 131 to become a closed chamber.

The heating assembly 14 is located on the bottom side of the inner box 13 and has electric heating coils 141 located thereon, and is coupled with a socket 142. The socket 142 is held in the anchor seat 113 of the base 11. The heating assembly 14 further has a thermostat 143 to control the heating temperature.

By means of the aforesaid structure, a heat preservation pad 1 is formed. The socket 142 can be coupled with a plug to receive electric power. After energized by the electric power, the heating assembly 14 generates heat energy to melt the wax W contained in the housing chamber 131 to become liquid. The heat can be transferred evenly to the entire heat receiving surface 123 to achieve a steady heating effect. The thermostat 143 can automatically cut off electric power to prevent overloading and overheating of the heat preservation pad 1. After being heated to a set temperature, the power supply can be unplugged from the heat preservation pad 1 so that the pad can be used for holding the pets. As the wax W has a low melting temperature and disperses heat slowly, it will release heat energy and condense slowly. Hence the heat preservation pad 1 can maintain a warm condition for a long period of time (about eight hours).

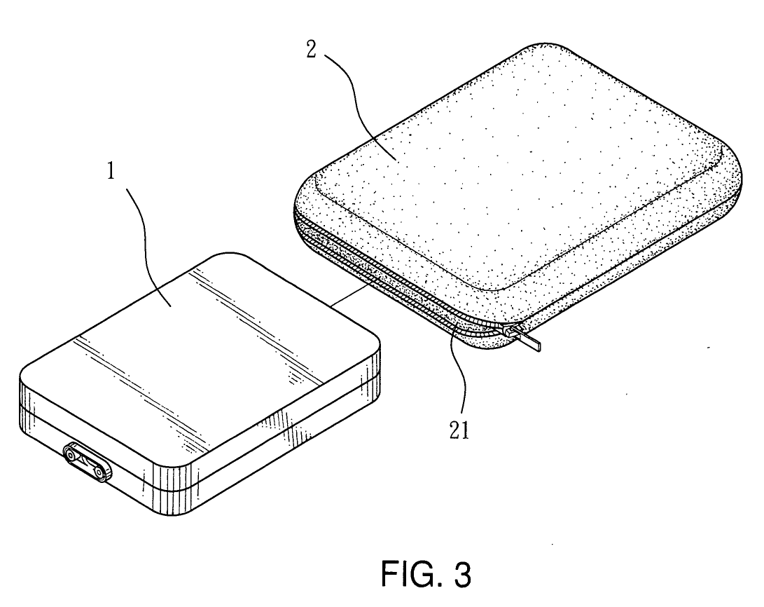

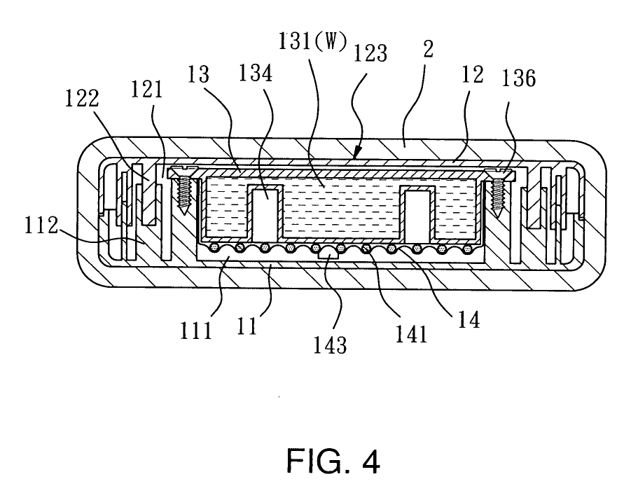

In addition, the heat preservation pad 1 can also be held in a pouch 2 (as shown in FIGS. 3 and 4). The pouch 2 is made from a pliable fabric and can aid heat preservation. It has an opening 21 on one end to facilitate loading and unloading of the heat preservation pad 1. Thus pets can seat and lie comfortably on the pad in a warm condition.

I claim:

1. A heat preservation pad comprising a base, a upper cap, an inner box and a heating assembly, wherein:
the base is coupled with the upper cap to form a chest which has a housing compartment to hold the inner box;
the upper cap covers a upper side of the base;
the inner box is located in the chest and has a housing chamber to hold wax;
the heating assembly is attached to a bottom surface of the inner box that has heating coils located thereon.

2. The heat preservation pad of claim 1, wherein the inner box has at least one trough on the bottom thereof.

3. The heat preservation pad of claim 1, wherein the heat preservation pad is held in a pouch which is made from a pliable fabric to aid heat preservation.

4. The heat preservation pad of claim 1, wherein the base has a plurality of coupling posts on the periphery, the upper cap having a plurality of struts on the periphery to be coupled with the coupling posts.

5. The heat preservation pad of claim 1, wherein the inner box has an opening on one end sealed by a lid to form a closed chamber.

6. The heat preservation pad of claim 1, wherein the heating coils have one end connecting to a socket which is fastened to an anchor seat located on the base.

7. The heat preservation pad of claim 1, wherein the heating assembly contains a thermostat.
